(19) United States
(12) Patent Application Publication
(10) Pub. No.: US 2012/0331124 A1
(43) Pub. Date: Dec. 27, 2012

(54) CONSTRAINT DEFINITION FOR CAPACITY MANGEMENT

(76) Inventors: Raman Ramteke Venkatesh, Bangalore (IN); SM Prakash Shiva, Bangalore (IN); Lee En, Bangalore (IN)

(21) Appl. No.: 13/166,385

(22) Filed: Jun. 22, 2011

(51) Int. Cl. G06F 15/16

(52) U.S. Cl. 709/224

(57) ABSTRACT

Methods, systems, and computer-readable media with executable instructions stored thereon for constraint definition for capacity management. Constraint definition for capacity management can include discovering a topology of a set of resources. A number of policy rules for the set of resources can be defined. A Dependency-Group (D-G) tree can be constructed according to the number of policy rules. Information obtained from the D-G tree can be converted into a set of resource placement constraint definitions understandable by a consolidation engine.

### BACKGROUND

With the increasing adaptation of cloud systems to run workloads, various businesses seek to decrease costs by better utilizing resources. One way to manage resources in cloud systems is through the implementation of virtual machines (VMs). Proper placement of VMs can further increase resource usage efficiency.

### BRIEF DESCRIPTION OF THE DRAWINGS

FIG. 1 is a flow chart illustrating an example of a method for constraint definition for capacity management.

FIG. 2 is a diagram illustrating an example of a Dependency-Group tree according to the present disclosure.

FIG. 3 illustrates a block diagram of an example of a computer-readable medium in communication with processing resources for constraint definition for capacity management.

### DETAILED DESCRIPTION

Examples of the present disclosure include methods, systems, and computer-readable media with executable instructions stored thereon for constraint definition for capacity management. Constraint definition for capacity management can include discovering a topology of a set of resources. A number of policy rules for the set of resources can be defined. A Dependency-Group (D-G) tree can be constructed according to the number of policy rules. Information obtained from the D-G tree can be converted into a set of resource placement constraint definitions understandable by a consolidation engine.

Datacenters (e.g., Configuration Management Databases (CMDBs)) can have a large number of Information Technology (IT) servers that support a number of business services for different business units. Static datacenters are configured to support a single operating system, data management system, application framework and a number of applications. Dynamic datacenters are capable of dynamically pooling, allocating, and managing resources. Increasingly, datacenters are being transformed from static to dynamic in attempts to lower costs and resource consumption associated with datacenter services. Datacenter transformation requires identification and definition of resource constraints prior to and during resource allocation. Constraints can include technical and business created constraints that should both be honored. Identifying and defining resource constraints can be a time consuming and error prone process. Automation of constraint definition for capacity management can provide resource placement recommendation that can be less prone to error and less time consuming.

In the present disclosure, reference is made to the accompanying drawings that form a part hereof, and in which is shown by way of illustration how one or more examples of the disclosure can be practiced. These examples are described in sufficient detail to enable those of ordinary skill in the art to practice the examples of this disclosure, and it is to be understood that other examples can be used and that process, electrical, and/or structural changes can be made without departing from the scope of the present disclosure.

The figures herein follow a numbering convention in which the first digit corresponds to the drawing figure number and the remaining digits identify an element or component in the drawing. Elements shown in the various figures herein can be added, exchanged, and/or eliminated so as to provide a number of additional examples of the present disclosure. In addition, the proportion and the relative scale of the elements provided in the figures are intended to illustrate the examples of the present disclosure, and should not be taken in a limiting sense.

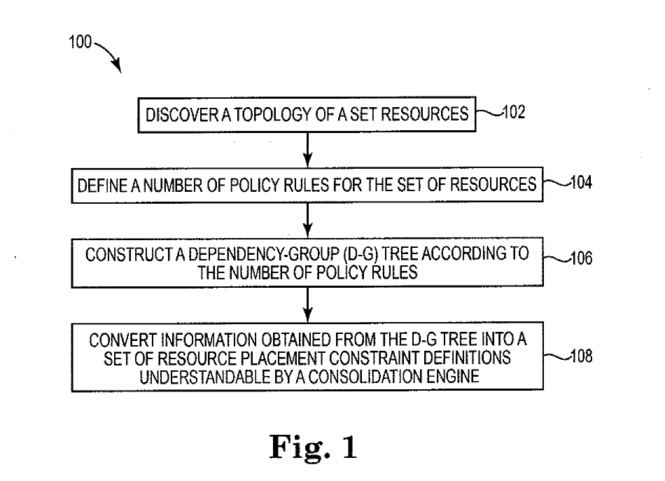

FIG. 1 is a flow chart illustrating an example of a method 100 for constraint definition for capacity management. At 102, a topology of a set of resources is discovered. A topology can, for example, be discovered by obtaining the topology of the set of resources from a datacenter. Datacenters can include, but are not limited to, a cloud, a Wide Area Network (WAN), an application, a cluster, a host level, a Configuration Management Database (CMDB), etc. In one or more examples, a topology can be a top-to-bottom list of resources and resource relationships associated with a business service. A resource can include, for example, standalone systems, virtual hosts, and/or virtual guests. Examples of resources include, but are not limited to, business services, business applications, clusters, Virtual Machine (VM) hosts, etc. A business service can include an Information Technology (IT) service that directly supports a business process, for example, a customer relationship management (CRM) business service that is hosted across multiple virtual machines.

A number of policy rules are defined for the set of resources, at 104. Policy rules can be defined by a user. In one or more examples, the number of policy rules can set forth guidelines that each of the resources of the set of resources in a business service should honor. Policy rules, for example, can be based on a number of policies, including, but not limited to: security, input/output bandwidth (I/O bandwidth), reducing an overall memory footprint, reducing network communication across hosts, licenses, etc. For example, a user can define a policy rule that VMWare guests should be hosted on VMWare hosts. In one or more examples, the defined number of policy rules does not address each resource of the set of resources discovered.

In one or more examples, it can be determined if the number of policy rules can be implemented in the constraint definition for capacity management. For example, an implementation determination can use the topology and a number of trend analysis statistics harvested from a number of Project Master Databases (PMDBs). Trend analysis statistics are statistics that can be used to spot a pattern or trend in the usage of the set of resources. Trend analysis statistics can include, but are not limited to: average central processing unit (CPU) utilization, average disk usage, number of uses logged in a network, etc. The trend analysis statistics can, for example, be harvested from the number of PMDBs by using a Performance Agent (PA), where a PA is a tool that collects system configuration and utilization statistics associated with various resources on heterogeneous operating systems and architectures. In an example, determining if the policy rules can be implemented can include analyzing the number of policy rules in view of the topology and the number of trend analysis statistics. For example, if a policy rule states that two different database servers should be placed on a common host, but the trend analysis statistics indicate that the bandwidth necessary for the two database servers is greater than the bandwidth of the common host, a determination that the policy rule cannot be implemented can be made. If it is determined that a policy rule cannot be implemented, the policy rule can be marked as invalid. In one or more examples, priority rules are considered on a first-defined-first-priority basis. For example, a first defined priority rule can outrank a latter defined priority rule regarding any potential inconstancies between the rules and/or the first defined priority rule can be considered first in resolving any free-to-place resources.

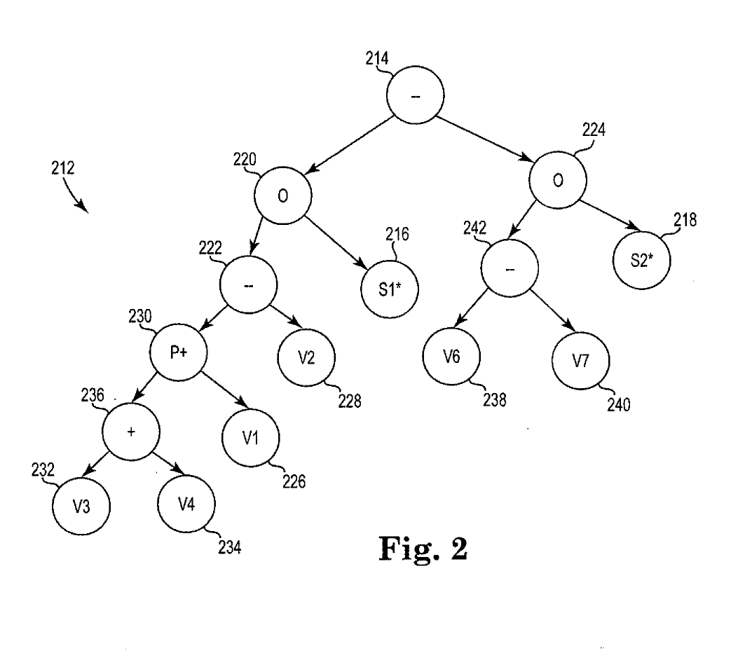

At 106, a Dependency-Group (D-G) tree can be constructed according to the number of policy rules. A D-G tree is a directed graph that represents the dependency of resources on one another. A D-G tree can be used to determine a number of interdependent resources of the set of resources. Construction of a D-G tree can, for example, include analyzing each of the number of policy rules; applying each of the number of policy rules; and, adjusting the D-G tree during construction to exhibit an efficient resource placement relationship. Adjusting can include re-ordering resources and/or balancing resources to abide by each of the number of policy rules. An example of a D-G tree is illustrated in FIG. 2.

A D-G tree can be a binary tree that includes a number of constraint nodes, a number of node-groups, and/or a number of Virtual-Machine (VM) nodes. A constraint-node can define the relationship that binds the left and right sub-tree of the node, where a sub-tree is a node or nodes that stem from another node. Types of constraint-nodes can include, but are not limited to, a must-apart node, a must-together node, a preferably-apart node, a preferably-together node, and an optional node. A must-apart node can be a constraint-node in which VM-nodes in the left and right sub-trees have to be placed on different hosts. In an example, a must-apart node can be denoted by a “−”. A must-together node can be a constraint-node in which the VM-nodes in left and right sub-trees have to be placed on the same host. In an example, a must-reside node can be denoted by a “+”. A preferably-apart node can be a constraint-node in which VM-nodes in the left and right sub-trees can be placed on different hosts unless overridden by a must-together constraint-node. In an example, a preferably-apart node can be denoted by a “P−”. A preferably-together node can be a constraint-node in which VM-nodes in the left and right sub-trees can be placed on the same host unless overridden by a must-apart constraint-node. In an example, a preferably-together node can be denoted by a “P+”. An optional node is a constraint-node in which there is no defined policy rule but is generated when, for example, the D-G tree is constructed and/or re-balanced. An optional node can indicate that sub-trees connected to the optional node are not bound by any policy rule. In an example, an optional node can be denoted by an “O”.

A node-group indicates a set of VMs as a single node. The set of VMs represented by a node-group can, for example, be associated with a common business service. For example, a set of VMs of a Service 1 can be denoted as “S1.” Types of node-groups can include, but are not limited to, partial node-groups and/or complete node-groups. A partial node-group indicates that not all VMs of the set of VMs that make-up the node-group are defined similarly. For example, a CRM node-group can be hosted across four VMs (e.g., V1, V2, V3, and V4). If a policy rule is defined on V1 of the CRM node-group then V1 would be denoted explicity by a VM node ‘V1’ on a D-G tree. The remaining VMs of the CRM node-group on which no policies have been defined, V2, V3, and V4, would form a partial node group denoted by ‘CRM*’ in the D-G tree. A complete node-group is a node which represents multiple nodes that can be grouped similarly in the D-G tree. For example, if two sets of VMs, CRM and Email, have an explicit policy rule of must-apart defined on the groups themselves and not on the individual VMs that make-up each set, then CRM and e-mail would explicitly be denoted as complete node-groups ‘CRM’ and ‘e-mail’ connected in D-G a tree by a constraint node. In an example, a “*” can denote a partial node-group (e.g., S1*). A VM node is a node that represents a single VM. In an example, a VM node can be denoted by a “V” followed by the number for the VM (e.g., V1, V2, etc.).

At 108, information obtained from the D-G tree can be converted into a set of resource placement constraint definitions understandable by a consolidation engine. In an example, converting the information obtained from the D-G tree can include resolving each of the number of defined policy rules regarding pinning a resource on a host and/or resolving a number of free-to-place constraint resources. A free-to-place constraint resource can be a resource that is not restricted to a specific host by any policy rule. In one or more examples, the number of free-to-place constraint resources can, for example, be arbitrarily assigned to a host, converted to a number of different resource placement constraint resources, or both. Types of resource placement constraint definitions include, but are not limited to: an apart constraint, a together constraint, a must-reside constraint, an exclusive constraint, a free-to-place constraint. An apart constraint definition can stipulate that two VMs should be placed on different hosts. A together constraint definition can stipulate that two VMs should be placed on the same host. A must-reside constraint definition can, for example, stipulate that a VM must be placed on a defined host. An exclusive constraint definition, for example, can stipulate that all VMs for an exclusive group should have exclusive VM hosts allocated which will not be shared with any VMs outside the group. A free-to place constraint can, for example, stipulate that a VM is not constrained by any policy rule or interdependency and can be placed anywhere in the D-G tree. In an example, the information obtained form the D-G tree can be converted by a consolidation engine. An example of a consolidation engine is, but is not limited to, Hewlett Packard's Service Health Operator (SHO) Smart Solver. A consolidation engine can take a number of forms including any tangible memory medium storing program instructions as any combination of hardware and program instructions. Regardless of its physical form, a consolidation engine, as used herein, is any engine configured to consolidate and/or place resources to better use resources in a database. Resource placement can, in an example, be recommended based on the set of resource placement constraint definitions.

FIG. 2 is a diagram 212 illustrating an example of a Dependency-Group tree according to the present disclosure. As discussed below, the D-G tree depicted in FIG. 2 can be constructed according a method for constraint definition for capacity management such as method 100 of FIG. 1.

In the example illustrated in FIG. 2, there are two business services, Enterprise Resource Planning (ERP) 216 and Finance 218. The topology for the two resources should be discovered (e.g., FIG. 1, 102). The topology for ERP Business Service 216 includes: VM V1: Oracle Server-1 226; VM V2: Oracle Server-2 228; VM V3: WebLogic Application Server-1 interacting with Oracle Server V1 232; VM V4: WebLogic Application Server-2 234; V10: FTP Server; V11: DNS Server; Host1: VM Host; Host2: VM Host; and Host3: VM Host. The topology for Finance Business Service 218 includes: VM V5: Sybase Server-1; VM V6: Sybase Server-2, 238; VM V7: Apache Application Server 240; VM V8: FTP Server; Host4: VM Host; and HostS: VH Host.

A set of policy rules should be defined for the above sets of resources (e.g., FIG. 1, 104). The example illustrated in FIG. 2 results from the following defined number of policy rules for the set of resources (FIG. 1, 104): Policy Rule 1: The ERP and Finance business services should not share any hosts for the reasons of security; Policy Rule 2: Database Servers should not reside on the same host, since the servers would be constrained by I/O bandwidth if they were placed together; Policy Rule 3: Application Servers should reside on the same host, since VMware could share memory pages between them and reduce the overall memory footprint; Policy Rule 4: If possible place all related application and database servers on the same host to reduce the network communication across hosts; and, Policy Rule 5: Oracle Server V1 should be placed on Host1, since there is a node-based Oracle license on Host1.

From the topology of the sets of resources and the defined policy rules the D-G Tree illustrated in FIG. 2 can be constructed (e.g., FIG. 1, 106). To implement policy rule 1, none of the VMs of the ERP and Finance business services can share any hosts. Therefore, policy rule 1 implies a must-apart node 214 between ERP partial node-group 216 and Finance partial node group 218.

From the CMDB discovered topology above, it is known that in Business Service ERP, VMs V1 226 and V2 228 are Oracle database servers and in Business Service Finance, VMs V6 238 and V7 240 are Sybase database servers. According to Policy Rule 2, the D-G tree 212 requires a must-apart node 222 between V1 226 and V2 228 within the ERP service 216 and a must-apart node 242 between V6 238 and V7 240 within the Finance service 218. The optional node 220 used to connect node 222 and node 216 indicates that the two sub-trees are not bound by any constraints. That is, the sub-tree that includes nodes 222, 226, 228, 230, 232, 234, and 236 is not bound by any placement constraint with the sub-tree that includes node 216. Also, the optional node 224 used to connect node 242 and node 218 indicates that the two sub-trees are not bound by any constraints.

The topology discovered above indicates that in Business Service ERP, VMs V3 232 and V4 234 are WebLogic servers and in Business Service Finance, VM V7 240 is an Apache application server. According to the defined Policy Rule 3, a must-together node 236 should be placed between V3 232 and V4 234 for the ERP service 216. Further, the Policy Rule 3 indicates that a must-together node should be placed between the ERP VMs V3, V4 232, 234 and the Finance VM V7 240. However, according to Policy Rule 1, none of the VMs of the ERP and Finance business services can share any hosts. That is, the ERP VMs V3, V4 232,234 cannot be on the same host as Finance VM V7 240. A must-together node between V3, V4 232,234 and V7 240 cannot be implemented and is therefore a policy violation. The policy rule requiring a must-together node or a preferably-together node among ERP and Finance services nodes could therefore be marked as invalid.

From the topology discovered above, it is known that in Business Service ERP, VM V3 232 is a WebLogic Application Server interacting with the Oracle Server V1 226. Policy Rule 4 states that if possible, place all related application and database servers on the same host. Policy Rule 4, therefore, requests that a preferably-together node 230 be placed between VM V3 232 and VM V1 226.

The preferably-together node between V1 226 and V3 232 applies to all nodes which are bounded by a preferably-together node or must-together node with V1 226 and V3 232. Therefore, VM V2 228 is separated from VMs V1,V3,V4 226, 232, 234 by a must-apart node 222 by the circumstances created by the policy rules in whole.

The D-G tree illustrated in FIG. 2 can be converted into a set of resource placement constraint definitions understandable by a consolidation engine (e.g., FIG. 1, 108). A consolidation engine can, for example, understand four explicit constraints: an apart constraint; a together constraint; a must-reside constraint; an exclusive constraint. Further, certain resources may not be constrained by any policy rule or interdependency. Such resources are free-to-place constrained and can be placed anywhere in the D-G tree. Converting the D-G tree into a set of resource placement constraint definitions can be a two step process.

First, the rules are resolved regarding the nodes connected to a host. As noted above, Policy Rule 5 constrains VM V1 226 to Host 1. Further, VMs V3, V4 232, 234 are bound by the preferably-together node 236 to VM V1 226. Therefore, VMs V3,V4 232,234 are also constrained to Host 1. Resolving Rule 5 with the remaining rules leads to the following resource placement constraint definitions:

Must-Reside (V1, Host1)

Must-Reside (V3, Host1)

Must-Reside (V4, Host1)

Second, the free-to-place constrained resources are resolved. The remaining nodes of the D-G tree not resolved in the first step are: S1* 216, S2* 218, V2 228, V6 238, and V7 240. These resources can be resolved by either assigning hosts randomly or converting them into constraints. Resolving the free-to-place resources of the D-G Tree 212, the following resource placement constraint definitions are generated:

Apart (V6, V7)

Apart (V1, V2)

Apart (V3, V2)

Apart (V4, V2)

UnassignedVMs(S1*) [for VMs V10 and V11 in ERP]

UnassignedVMs(S2*) [for VM V8 in Finance]

Exclusive (V1, V2, V3, V4, S1*) or Exclusive(ERP)

Exclusive(V6, V7, S2*) or Exclusive(Finance).

The above resource constraint definitions can be directly inputted to a consolidation engine. The consolidation engine can then provide a placement recommendation for each of the resources of the sets of resources that satisfies the defined resource placement constraints.

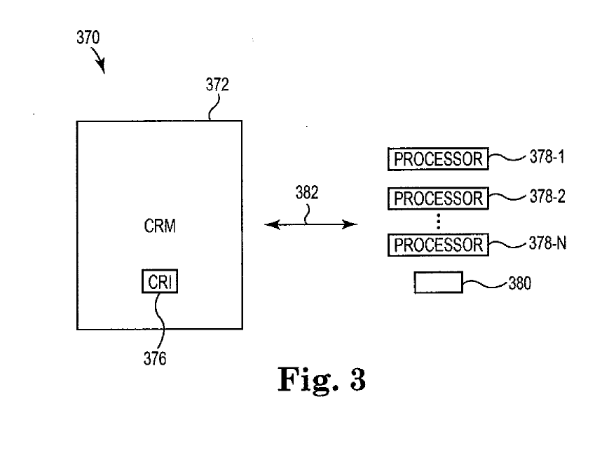

FIG. 3 illustrates a block diagram 370 of an example of a computer-readable medium in communication with processing resources for constraint definition for capacity management according to the present disclosure. Computer-readable medium (CRM) 372 can be in communication with processor resources of more or fewer than 378-1, 378-2, . . . , 378-N, that can be in communication with, and/or receive a tangible non-transitory CRM 372 storing a set of computer-readable instructions 376 executable by one or more of the processor resources (e.g., 378-1, 378-2, . . . , 378-N) for constraint definition for capacity management as described herein. In one or more examples, processor resources 378-1, 378-2, . . . 378-N can be in one or more devices which can include memory resources 380, and the processor resources 378-1, 378-2, . . . , 378-N can be coupled to the memory resources 380. For example, the one or more devices including the processor resources 378-1, 378-2, . . . 378-N and/or memory resources 380 can be in a cloud computing system (e.g., multiple devices in different locations).

Processor resources can execute computer-readable instructions 376 for constraint definition for capacity management that are stored on an internal or external non-transitory computer-readable medium 372. A non-transitory computer-readable medium (e.g., computer readable medium 372), as used herein, can include volatile and/or non-volatile memory. Volatile memory can include memory that depends upon power to store information, such as various types of dynamic random access memory (DRAM), among others. Non-volatile memory can include memory that does not depend upon power to store information. Examples of non-volatile memory can include solid state media such as flash memory, EEPROM, phase change random access memory (PCRAM), magnetic memory such as a hard disk, tape drives, floppy disk, and/or tape memory, optical discs, digital video discs (DVD), Blu-ray discs (BD), compact discs (CD), and/or a solid state drive (SSD), flash memory, etc., as well as other types of CRM.

The non-transitory computer-readable medium 372 can be integral, or communicatively coupled, to a computing device, in either in a wired or wireless manner. For example, the non-transitory CRM can be an internal memory, a portable memory, a portable disk, or a memory located internal to another computing resource (e.g., enabling the computer-readable instructions to be downloaded over the Internet).

The CRM 372 can be in communication with the processor resources (e.g., 378-1, 378-2, . . . , 378-N) via a communication path 382. The communication path 382 can be local or remote to a machine associated with the processor resources 378-1, 378-2, . . . , 378-N. Examples of a local communication path 382 can include an electronic bus internal to a machine such as a computer where the CRM 372 is one of volatile, non-volatile, fixed, and/or removable storage medium in communication with the processor resources (e.g., 378-1, 378-2, . . . , 378-N) via the electronic bus. Examples of such electronic buses can include Industry Standard Architecture (ISA), Peripheral Component Interconnect (PCI), Advanced Technology Attachment (ATA), Small Computer System Interface (SCSI), Universal Serial Bus (USB), among other types of electronic buses and variants thereof.

The communication path 382 can be such that the CRM 372 is remote from the processor resources (e.g., 378-1, 378-2, . . . , 378-N) such as in the example of a network connection between the CRM 372 and the processor resources (e.g., 378-1, 378-2, . . . , 378-N). That is, the communication path 382 can be a network connection. Examples of such a network connection can include a local area network (LAN), a wide area network (WAN), a personal area network (PAN), and the Internet, among others. In such examples, the CRM 372 can be associated with a first computing device and the processor resources (e.g., 378-1, 378-2, . . . , 378-N) can be associated with a second computing device.

Processor resources 378-1, 378-2, . . . , 378-N coupled to the memory 380 can discover a topology of a set of resources. Further, processor resources 378-1, 378-2, . . . , 378-N can define a number of policy rules for the set of resources. Processor resources 378-1, 378-2, . . . , 378-N can, for example, determine if the number of policy rules can be implemented. The policy rules can then be used to construct a D-G tree according to the number of policy rules. Processor resources 378-1, 378-2, . . . , 378-N can adjust the D-G tree to exhibit an efficient placement relationship. The number of policy rules regarding pinning a resource on a host and a number of free-to-pace resources can be resolved.

Processor resources 378-1, 378-2, . . . , 378-N coupled to the memory 380 can convert information obtained from the D-G tree into a set of resource placement constraint definitions understandable by a consolidation engine. A resource placement can be recommended based on the set of resource placement constraint definitions.

The above specification, examples and data provide a description of the method and applications, and use of the system and method of the present disclosure, Since many examples can be made without departing from the spirit and scope of the system and method of the present disclosure, this specification merely sets forth some of the many possible example configurations and implementations.

Although specific examples have been illustrated and described herein, those of ordinary skill in the art will appreciate that an arrangement calculated to achieve the same results can be substituted for the specific examples shown. This disclosure is intended to cover adaptations or variations of one or more examples of the present disclosure. It is to be understood that the above description has been made in an illustrative fashion, and not a restrictive one. Combination of the above examples, and other examples not specifically described herein will be apparent to those of skill in the art upon reviewing the above description. The scope of the one or more examples of the present disclosure includes other applications in which the above structures and methods are used. Therefore, the scope of one or more examples of the present disclosure should be determined with reference to the appended claims, along with the full range of equivalents to which such claims are entitled.

Throughout the specification and claims, the meanings identified below do not necessarily limit the terms, but merely provide illustrative examples for the terms. The meaning of “a,” “an,” and “the” includes plural reference, and the meaning of “in” includes “in” and “on.” The term “a number of” is meant to be understood as including at least one but not limited to one. The phrase “in an example,” as used herein does not necessarily refer to the same example, although it can.

What is claimed:

1. A method for constraint definition for capacity management, comprising:
discovering a topology of a set of resources;
defining a number of policy rules for the set of resources;
constructing a Dependency-Group (D-G) tree according to the number of policy rules; and
converting information obtained from the D-G tree into a set of resource placement constraint definitions understandable by a consolidation engine.

2. The method of claim 1, further comprising:
determining if the number of policy rules can be implemented, including:
using the topology;
harvesting a number of trend analysis statistics from a number of Project Master Databases (PMDBs); and
analyzing the number of policy rules in view of the topology and the number of trend analysis statistics.

3. The method of claim 1, wherein constructing the D-G tree includes:
analyzing each of the number of policy rules;
applying each of the number of policy rules; and
adjusting the D-G tree to exhibit an efficient resource placement relationship.

4. The method of claim 1, wherein the topology information is discovered from a configuration management database (CMDB).

5. The method of claim 1, wherein the D-G tree further includes a number of constraint nodes, a number of node-groups, and a number of Virtual Machine (VM) nodes.

6. The method of claim 5, wherein the number of constraint nodes include:
a must-apart node;
a must-together node;
a preferably-apart node;
a preferably-together node;
an optional node.

7. The method of claim 1, wherein converting the information obtained from the D-G tree includes:
resolving each of the number of policy rules regarding pinning a resource of the set of resources on a host; and
resolving a number of free-to-place resources.

8. A non-transitory computer-readable medium including computer-readable instructions stored thereon that, when executed by one or more processors, cause the one or more processors to:
discover a topology of a set of resources;
define a number of policy rules for the set of resources;
determine if the number of policy rules can be implemented;
construct a Dependency-Group (D-G) tree according to the number of policy rules;
convert information obtained from the D-G tree into a set of resource placement constraint definitions understandable by a consolidation engine; and
recommend resource placement based on the set of resource placement constraint definitions.

9. The non-transitory computer-readable medium of claim 8, wherein the D-G tree includes at least a number of node-groups, wherein the number of node groups include a partial node-group, a complete node-group.

10. The non-transitory computer-readable medium of claim 8, wherein the instructions to determine if the number of policy rules can be implemented further include instructions to: mark a policy rule as invalid if the policy rule cannot be implemented.

11. The non-transitory computer-readable medium of claim 8, wherein the instructions to convert the information of the D-G tree further includes instructions to:
resolve each of the number of policy rules regarding a resource of the set of resources pinned on a host; and
resolve a number of free-to-place constraint resources by arbitrarily assigning the number of free-to-place constraint resources.

12. The non-transitory computer-readable medium of claim 8, wherein the set of resource placement constraint definitions include:
an apart constraint;
a together constraint;
a must-reside constraint;
an exclusive constraint;
a free-to-place constraint.

13. A system for constraint definition for capacity management, comprising:
a memory operable to store executable instructions; and
a processor coupled to the memory, wherein the processor executes the instructions to:
discover a topology of a set of resources from a configuration management database (CMDB);
define a number of policy rules for the set of resources;
determine if the number of policy rules can be implemented;
construct a Dependency-Group (D-G) tree according to the number of policy rules;
adjust the D-G tree to exhibit an efficient placement relationship;
resolve each of the number of policy rules regarding a resource of the set of resources pinned on a host;
resolve a number of free-to-place resources;
convert information obtained from the D-G tree into a set of resource placement constraint definitions understandable by a consolidation engine; and
recommend resource placement based on the set of resource placement constraint definitions.

14. The system of claim 13, wherein the instructions to convert further include instructions to:
convert a number of free-to-place constraint resources into a number of different resource placement constraint resources.

15. The system of claim 14, wherein the number of different resource placement constraint definitions include a number of apart constraints, a number of together constraints, a number of must-reside constraints, a number of exclusive constraints.
